(19) United States
(12) Patent Application Publication
(10) Pub. No.: US 2015/0261492 A1
(43) Pub. Date: Sep. 17, 2015

(54) INFORMATION PROCESSING APPARATUS, INFORMATION PROCESSING METHOD, AND INFORMATION PROCESSING SYSTEM

(71) Applicant: SONY CORPORATION, TOKYO (JP)

(72) Inventors: KOICHI KAWASAKI, TOKYO (JP); NAOYUKI SATO, TOKYO (JP); AKIHIKO IZUMI, KANAGAWA (JP)

(21) Appl. No.: 14/638,560

(22) Filed: Mar. 4, 2015

(30) Foreign Application Priority Data
Mar. 13, 2014 (JP) 2014-049943

(51) Int. Cl. G06F 3/14; G02B 27/01; G09G 5/12

(52) U.S. Cl. CPC G06F 3/1423; G09G 5/12; G02B 27/017; G09G 2370/20; G02B 2027/0178

(57) ABSTRACT

There is provided an information processing apparatus, including an information acquisition section which acquires display information, and a first display section which displays the display information. A display of the display information is controlled for the first display section, in accordance with a relative positional relationship between the first display section and a second display section provided in an external apparatus, based on at least one of a control of a display destination of the display information between the first display section and the second display section, and a control of a layout of the display information displayed on the first display section.

### CROSS REFERENCE TO RELATED APPLICATIONS

This application claims the benefit of Japanese Priority Patent Application JP 2014-049943 filed Mar. 13, 2014, the entire contents of which are incorporated herein by reference.

### BACKGROUND

The present disclosure relates to an information processing apparatus, an information processing method and an information processing system.

In recent years, various types of terminals have been proposed, as wearable computers capable of being worn on the body of a user and carried. Among such wearable computers, there is a glasses-type information terminal (hereinafter, there will be cases where this is simply called a “glasses-type terminal”) in which the lens portion of the glasses is constituted as a transmissive-type display (refer to JP 2013-077031A).

By utilizing the characteristics of such a glasses-type terminal, for example, it becomes possible to display information presented on the glasses-type terminal side superimposed onto objects observed through the transmissive-type display or information presented by another information terminal.

### SUMMARY

On the other hand, in the case where information displayed on a display section (display) of another information processing apparatus such as a smartphone, for example, is observed through a display section (transmissive-type display) of the glasses-type terminal, there will be case where the information displayed on both of the display sections is superimposed, and distinction of each type of information becomes difficult. Further, since the distance from the eyes of a user up to the display section will be different for each of the glasses-type terminal and the other information processing apparatus, it may be necessary for a user to focus on each of the display sections in order to refer to both types of information, and there will be many cases where this operation leads to eye fatigue.

Accordingly, the present disclosure proposes a new and improved information processing apparatus, information processing method and information processing system, in the case where information is presented by a plurality of information processing apparatuses, capable of presenting each type of information in an easier to view mode.

According to an embodiment of the present disclosure, there is provided an information processing apparatus, including an information acquisition section which acquires display information, and a first display section which displays the display information. A display of the display information is controlled for the first display section, in accordance with a relative positional relationship between the first display section and a second display section provided in an external apparatus, based on at least one of a control of a display destination of the display information between the first display section and the second display section, and a control of a layout of the display information displayed on the first display section.

According to another embodiment of the present disclosure, there is provided an information processing method, including acquiring display information, displaying, by a processor, the display information on a first display section, and controlling a display of the display information to the first display section, in accordance with a relative positional relationship between the first display section and a second display section provided in an external apparatus, based on at least one of a control of a display destination of the display information between the first display section and the second display section, and a control of a layout of the display information displayed on the first display section.

According to still another embodiment of the present disclosure, there is provided an information processing system, including a first information processing apparatus including a first display section, a second information processing apparatus including a second display section, and a control section which controls, in accordance with a relative positional relationship between the first display section and the second display section, at least one of a display destination of display information between the first display section and the second display section, and a layout of the display information displayed on the first display section.

According to yet another embodiment of the present disclosure, there is provided an information processing apparatus, including an information acquisition section which acquires display information, and a control section which controls, in accordance with a relative positional relationship between a first display section and a second display section provided in a different apparatus to the first display section, at least one of a display destination of the display information between the first display section and the second display section, and a layout of the display information displayed on the first display section.

According to an embodiment of the present disclosure such as described above, an information processing apparatus, an information processing method and an information processing system are proposed, in the case where information is presented by a plurality of information processing apparatuses, capable of presenting each type of information in an easier to view mode.

Note that the effects described above are not necessarily limited, and along with or instead of the effects, any effect that is desired to be introduced in the present specification or other effects that can be expected from the present specification may be exhibited.

### BRIEF DESCRIPTION OF THE DRAWINGS

FIG. 1 is an explanatory diagram for describing a schematic system configuration of an information processing system according to an embodiment of the present disclosure;

FIG. 2 is an explanatory diagram for describing an example of a schematic configuration of a glasses-type information processing apparatus according to a same embodiment;

FIG. 3 is an explanatory diagram for describing an outline of the information processing system according to a same embodiment;

FIG. 4 is an explanatory diagram for describing an outline of the information processing system according to a same embodiment;

FIG. 5 is an explanatory diagram for describing another example of a system configuration of the information processing system according to a same embodiment;

FIG. 6 shows an example of a hardware configuration of an information processing apparatus according to a same embodiment;

FIG. 7 is a block diagram which shows an example of a schematic functional configuration of the information processing system according to a same embodiment;

FIG. 8 is a flow chart which shows an example of the processes related to a start of coordination between the glasses-type terminal and another information processing apparatus according to a same embodiment;

FIG. 9 is an activity diagram which shows an example of the processes related to an end of coordination between the glasses-type terminal and another information processing apparatus according to a same embodiment;

FIG. 10 is an activity diagram which shows an example of the processes related to coordination between the glasses-type terminal and another information processing apparatus according to a same embodiment;

FIG. 11 is an explanatory diagram for describing an outline of the information processing system according to a first modified example;

FIG. 12 is an explanatory diagram for describing an outline of the information processing system according to a second modified example;

FIG. 13 is an explanatory diagram for describing an outline of the information processing system according to a third modified example; and

FIG. 14 is an explanatory diagram for describing an outline of the information processing system according to a fourth modified example.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

The description will be given in the following order.

1. Outline

1.1. System configuration

1.2. Schematic operations of the information processing system

2. Hardware configuration

3. Functional configuration

4. Processes

5. Modified examples

5.1. First modified example

5.2. Second modified example

5.3. Third modified example

5.4. Fourth modified example

6. Summary

### 1. OUTLINE

### 1.1. System Configuration

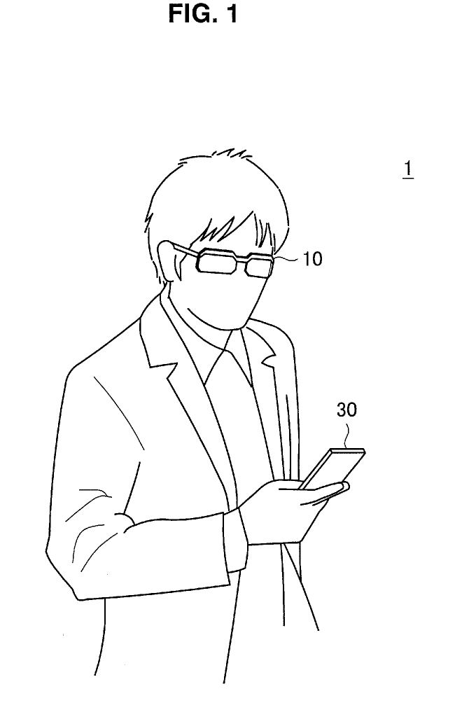

First, a schematic system configuration of an information processing system according to an embodiment of the present disclosure will be described with reference to FIG. 1. FIG. 1 is an explanatory diagram for describing a schematic system configuration of an information processing system according to the present embodiment.

As shown in FIG. 1, the information processing system 1 according to the present embodiment includes information processing apparatuses 10 and 30. The information processing apparatus 10 can be constituted, for example, as a glasses-type information processing apparatus in which the portion of the lens is constituted as a transmissive-type display. Further, the information processing apparatus 30 includes a display section (display) constituted as a housing different to that of the information processing apparatus 10 (that is, an external apparatus). The information processing apparatus 30 may be, for example, a portable user terminal such as a smartphone, or may be an information processing terminal such as a PC.

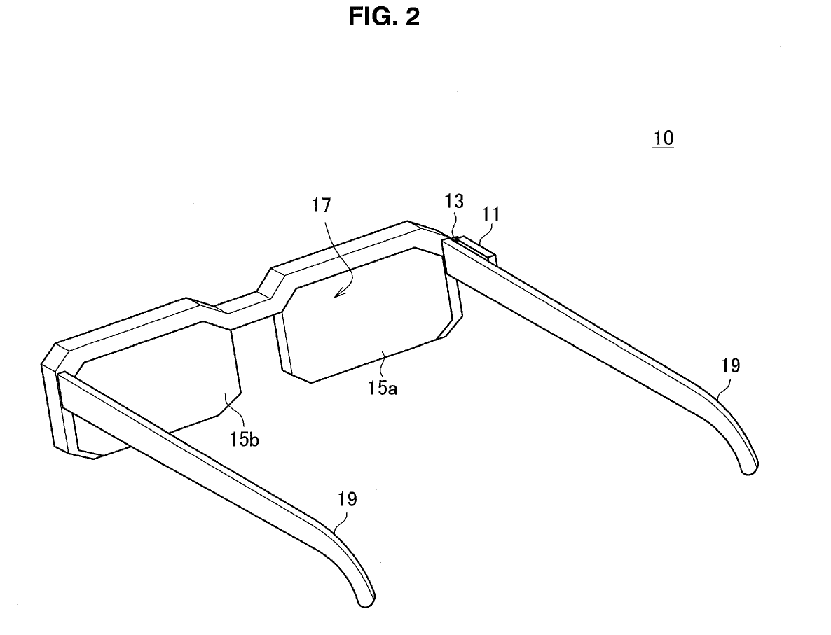

Here, an example of the configuration of the glasses-type information processing apparatus 10 will be further described in detail with reference to FIG. 2. FIG. 2 is an explanatory diagram for describing an example of a schematic configuration of the glasses-type information processing apparatus 10 according to the present embodiment. Note that, in order to easily understand the description, there will be cases hereinafter where the glasses-type information processing apparatus 10 is differentiated from the information processing apparatus 30 and called a “glasses-type terminal 10”.

As shown in FIG. 2, the glasses-type terminal 10 includes, for example, lenses 15a and 15b, a holding section 19, an information processing unit 11, and a position information acquisition section 13. In FIG. 2, the lens 15b corresponds to a lens for the left eye held in front of the left eye, and the lens 15a corresponds to a lens for the right eye held in front of the right eye. Note that, in the glasses-type terminal 10 according to the present embodiment, the lenses 15a and 15b may not necessarily have a function which corrects the vision of a user, that is, a function for performing divergence or convergence by refracting light.

The holding section 19 corresponds to a frame of the glasses, for example, and holds the glasses-type terminal 10 on the head of a user, so that the lenses 15a and 15b are held in front of the eyes of the user.

Further, a display section 17 for displaying information or content may be formed in at least a part of the region in either of the lenses 15a and 15b. A liquid display panel, for example, is used in the display section 17, and is constituted to be capable of being controlled in a through state, that is, in a transparent or non-transparent state, by controlling the transmittance.

Note that, the above described configuration of the display section 17 is merely an example, and this configuration will not be particularly limited, if at least a part of the region in at least either of the lenses 15a and 15b can be implemented as the display section 17 for displaying information. For example, by including an image projection device which sets a part of the region of the lens 15a to a projection surface, this part of the region may be set to the display section 17. Further, both of the lenses 15a and 15b may not be necessarily included, and only one of the lenses 15a and 15b may be included, and this lens used as the display section 17. Note that, it is needless to say that, in the case where only one of the lenses 15a and 15b is included, the configuration of the holding section 19 will not be limited to the example shown in FIG. 2, and may be arbitrarily changed. Further, it is needless to say that, in the case where the lens in which at least the display section 17 is included, out of the lenses 15a and 15b, is implemented as a transmissive-type display, the lenses 15a and 15b may be formed, for example, by a transparent material such as resin or glass.

Further, in at least one of the lenses 15a and 15b, a control unit for operating at least a part of the region as the display section 17 may be included at some position of the holding section 19, for example, and may be implemented as a function of a part of an information processing unit 11, which will be described later.

Further, while an example has been described heretofore which implements the lenses in which at least the display section 17 is included, out of the lenses 15a and 15b, as a transmissive-type display, it is not necessarily limited to a configuration which is implemented by a transmissive-type display, such as described above. For example, all surfaces of the portions corresponding to the lenses 15a and 15b may be constituted as a display, or may be constituted, by including an imaging section which captures separate visual line directions, for displaying an image captured by the imaging section on this display corresponding to the lenses 15a and 15b.

The position information acquisition section 13 and the information processing unit 11 are held, for example, in a part of the holding section 19. As a specific example, in the example shown in FIG. 2, the position information acquisition section 13 and the information processing unit 11 are held in a portion which corresponds to the temple of the glasses. Note that, the position at which the position information acquisition section 13 and the information processing unit 11 are held will not be particularly limited, if each of the functions of the position information acquisition section 13 and the information processing unit 11, which will be described hereinafter, are capable of being implemented.

In the case where the information processing apparatus 30 is present in a direction of an opposite side to a direction the display section 17 presents information towards a user, the position information acquisition section 13 acquires information (hereinafter, there will be cases where this is called “position information”) for specifying a position of the display section 31 of the information processing apparatus 30. Here, in the case where a user is wearing the glasses-type terminal 10 on his or her head, the direction the display section 17 presents information towards the user shows the direction in which the eyes of this user are positioned with respect to the display section 17. That is, the position information acquisition section 13 acquires position information of the display section 31 of the information processing apparatus 30 present in a direction of an opposite side to the eyes of the user with respect to the display section 17, that is, in front of the user wearing the glasses-type terminal 10 (hereinafter, there will be cases where this is called “in front of the glasses-type terminal 10”).

The position information acquisition section 13 can be constituted, for example, by an imaging section which captures an image in front of the glasses-type terminal 10. In this case, it is possible to specify a relative position, orientation and distance (hereinafter, there will be cases in which these are collectively called a “relative position”) of the display section 31 with respect to the display section 17 of the glasses-type terminal 10, by the position, orientation and size of the display section 31 (or the information processing apparatus 30) within an image captured by the position information acquisition section 13. Further, it is needless to say that it is possible to recognize whether or not the information processing apparatus 30 is present in front of this glasses-type terminal 10, in accordance with whether or not the information processing apparatus 30 has been captured within an acquired image.

Further, the configuration of the position information acquisition section 13 will not be limited to an imaging section, if it possible to specify a relative position of the display section 31 with respect to the display section 17. For example, by having the position information acquisition section 13 constituted by various types of sensors or the like, a relative position of the display section 31 of the information processing apparatus 30 present in front of the glasses-type terminal 10 may be sensed.

Further, at this time, the information processing apparatus 30 may notify the glasses-type terminal 10 that it is an external apparatus which becomes a target of coordination. As a specific example, the information processing apparatus 30 may notify the glasses-type terminal 10 that it is an external apparatus which becomes a target of coordination, by flashing or lighting a light emitting element, such as a Light Emitting Diode (LED) included near to the display section 31, with a luminance pattern determined in advance.

In this case, for example, the glasses-type terminal 10 may recognize that this information processing apparatus 30 is an external apparatus which becomes a target of coordination, based on the luminance pattern of the light emitting element included in the information processing apparatus 30 within a captured image. Note that, the example shown above is merely an example, and this method will not be particularly limited, if it is possible to recognize that the information processing apparatus 30 is an external apparatus which becomes a target of coordination at the glasses-type terminal 10 side. Accordingly, for example, the information processing apparatus 30 may notify the glasses-type terminal 10 that it is an external apparatus which becomes a target of coordination, by displaying an image (for example, a two-dimensional code or the like) for recognizing itself on the display section 31. According to such a configuration, for example, even in the case where a plurality of information processing apparatuses 30 have been recognized, it becomes possible for the glasses-type terminal 10 to specify the information processing apparatus 30 which becomes a target of coordination, based on the above described notification.

The information processing unit 11 specifies a relative positional relationship between the display section 17 of the glasses-type terminal 10 and the display section 31 of the information processing apparatus 30, based on position information of the display section 31 of the information processing apparatus 30 acquired by the position information acquisition section 13. Note that, the specific method of the relative positional relationship between the display section 17 and the display section 31 is such as that described above in conjunction with the description of the position information acquisition section 13.

Further, the information processing unit 11 is constituted to be capable of communicating with the information processing apparatus 30 (that is, the external apparatus which coordinates with the glasses-type terminal 10), and notifies this information processing apparatus 30 of information which shows the specified relative positional relationship between the display section 17 and the display section 31. According to such a configuration, it becomes possible for the information processing apparatus 30 to recognize the relative positional relationship of the display section 31 with respect to the display section 17, based on information notified from the information processing unit 11.

Note that, it is needless to say that, in the case where it may not be necessary to recognize the relative positional relationship between the display section 17 and the display section 31, at the information processing apparatus 30 side, it may not be necessary to notify information which shows this positional relationship from the glasses-type terminal 10 to the information processing apparatus 30. As a specific example, in the case where the glasses-type terminal 10 proactively executes a control based on the relative positional relationship between the display section 17 and the display section 31, it may not be necessary to notify information which shows this positional relationship to the information processing apparatus 30.

In the information processing system 1 according to the present embodiment, coordination is performed between the display of information to the display section 17 and the display of information to the display section of the information processing apparatus 30, based on the specified relative positional relationship between the glasses-type terminal 10 and the information processing apparatus 30. Accordingly, an outline of the operations of the information processing system 1 according to the present embodiment will be described hereinafter.

### 1.2. Schematic Operations of the Information Processing System

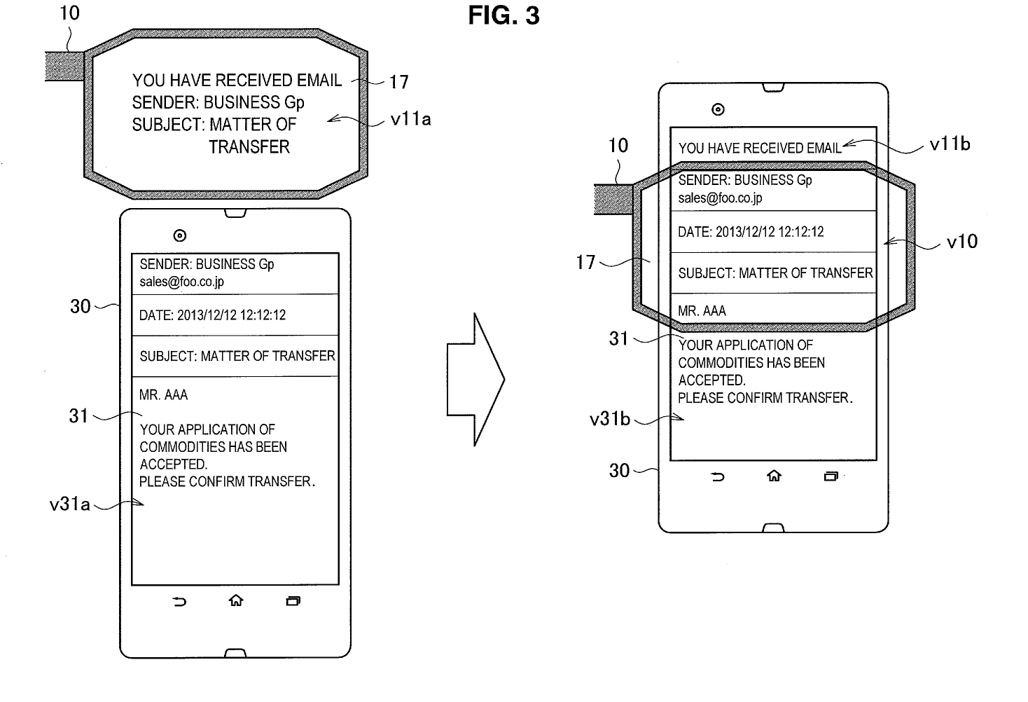

An outline of the operations of the information processing system 1 according to the present embodiment will be described with reference to FIG. 3. FIG. 3 is an explanatory diagram for describing an outline of the information processing system 1 according to the present embodiment.

For example, the left side of FIG. 3 shows a state in which the display section 31 of the information processing apparatus 30 is not present within the visual field of a user via the display section 17 of the glasses-type terminal 10 constituted as a transmissive-type display. At this time, display information v11a is displayed on the display section 17, and display information v31a is displayed on the display section 31.

Further, the right side of FIG. 3 shows a state in which a user observes the display section 31 through the display section 17, in other words, a state in which the display section 31 is present within a prescribed region of a direction of an opposite side to a direction the display section 17 presents display information towards the user. In this case, mutual coordination is performed between the glasses-type terminal 10 and the information processing apparatus 30 according to the present embodiment, the display information displayed on each of the display sections is integrated and displayed on one of the display sections, and a display of information is limited for the other display section. Note that, the limitation of a display of information in the present disclosure can include, for example, the case where the display of information is stopped, the case where a part of the information is set to a non-display, or the case where a part of the display information is retracted to a position not obstructing the visual field of a user such as a screen edge or the like.

For example, in the case of the example shown on the right side of FIG. 3, the display information v11a displayed on the display section 17 is transmitted to the information processing apparatus 30 side, and is displayed on the display section 31 as display information v11b. Further, at this time, the information processing apparatus 30 may secure a region for displaying the display information v11b, by changing a part of the layout of the display information v31a displayed on the display section 31. Further, by receiving a display of the display information v31b to the display section 31, the glasses-type terminal 10 stops the display of information to the display section 17 (that is, sets to a non-display state in which information is not displayed), such as shown in the reference numeral v10.

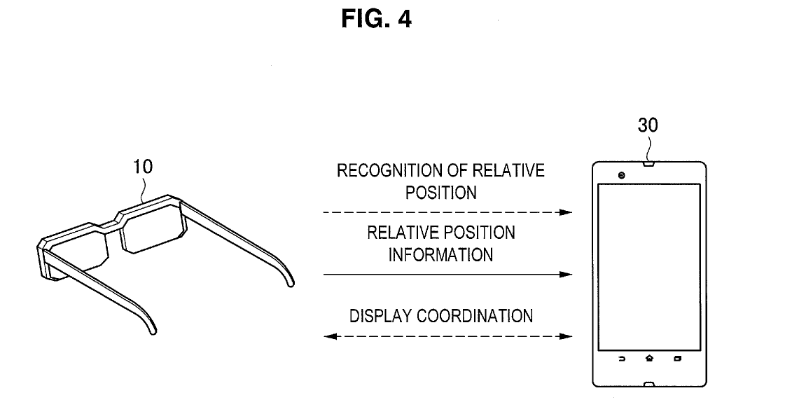

Here, schematic operations of the information processing system 1 according to the present embodiment will be described with reference to FIG. 4. FIG. 4 is an explanatory diagram for describing an outline of an information processing system according to the present embodiment.

The glasses-type terminal 10 confirms whether or not the information processing apparatus 30 is present in front of this glasses-type terminal 10, based on the above described position information notified from the position information acquisition section 13 (refer to FIG. 2). Then, in the case where the information processing apparatus 30 is present in front of this glasses-type terminal 10, the glasses-type terminal 10 recognizes a relative position of the display section 31 with respect to the display section 17, and notifies the information processing apparatus 30 of relative position information which shows the recognized relative position. In this way, it becomes possible to recognize a mutual relative positional relationship between the glasses-type terminal 10 and the information processing apparatus 30, and to mutually coordinate a display of information to the display sections, in accordance with this positional relationship.

According to such a configuration, for example, in the case where a user observes the display section 31 through the display section 17, such as shown in FIG. 3, the information processing apparatus 30 integrates the display information displayed on each of the display sections 17 and 31 on the display section 31 side. Then, the glasses-type terminal 10 causes a display of information to the display section 17 to be stopped.

Note that, the subject of control related to a display of display information to the display sections 17 and 31, based on coordination between the glasses-type terminal 10 and the information processing apparatus 30, is not particularly limited. For example, it may be a configuration in which one of the glasses-type terminal 10 and the information processing apparatus 30 becomes the subject of control, and the other performs subordinate operations based on this control. It may be a configuration in which both the glasses-type terminal 10 and the information processing apparatus 30 are independently operated, and a display of display information to the respective display sections is controlled, in accordance with a mutual state (for example, a relative position).

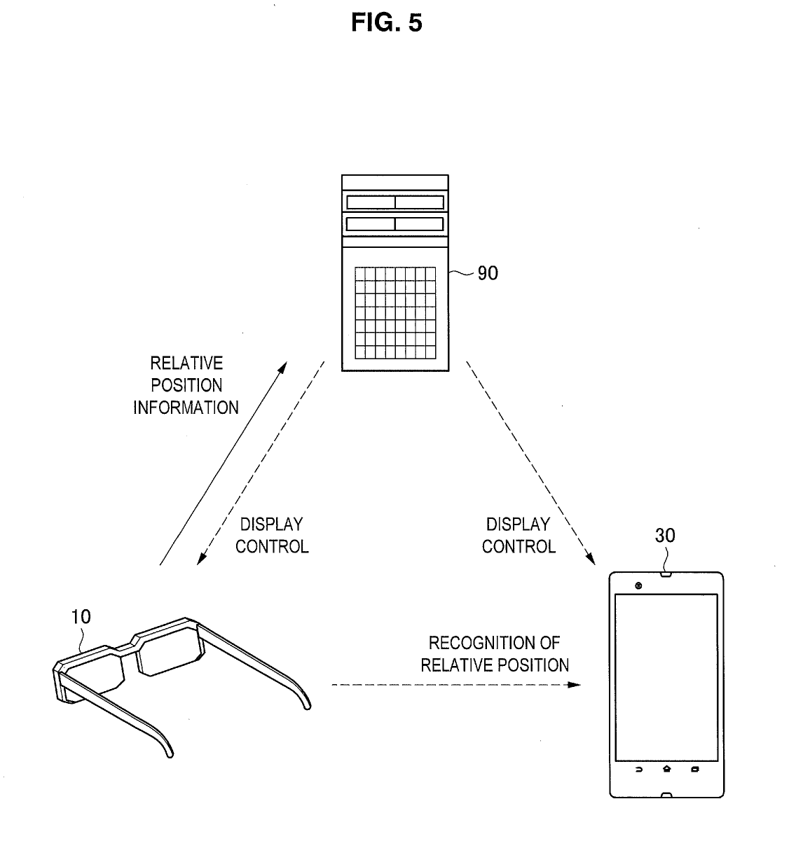

Further, as another example, the subject of control related to a display of display information to the display sections 17 and 31, based on coordination between the glasses-type terminal 10 and the information processing apparatus 30, may be included separately from the glasses-type terminal 10 and the information processing apparatus 30. For example, FIG. 5 shows, as another example of a system configuration of the information processing system 1 according to the present embodiment, an example of the case where the control subject related to a display of display information to the display sections 17 and 31 is included separately from the glasses-type terminal 10 and the information processing apparatus 30.

In the example shown in FIG. 5, a control apparatus 90 is included in addition to the glasses-type terminal 10 and the information processing apparatus 30. The control apparatus 90 is constituted to be capable of communicating with both the glasses-type terminal 10 and the information processing apparatus 30, and controls the glasses-type terminal 10 and the information processing apparatus 30, via this communication.

In the case of the example shown in FIG. 5, for example, the glasses-type terminal 10 notifies the control apparatus 90 of relative position information which shows the specified relative position of the display section 31 with respect to the display section 17. By receiving this notification, the control apparatus 90 may recognize the relative positional relationship between the display section 17 and the display section 31, based on the notified relative position information, and may control a display of information to the display sections of each of the glasses-type terminal 10 and the information processing apparatus 30, in accordance with this positional relationship.

Further, while the examples shown in FIG. 4 and FIG. 5 show configurations in which the glasses-type terminal 10 recognizes a relative position of the information processing apparatus 30 with respect to this glasses-type terminal 10, the subject which recognizes a relative position may be at the information processing apparatus 30 side. This subject will not be particularly limited, if at least a relative positional relationship between the display section 17 and the display section 31 can be recognized. Accordingly, for example, it may be a configuration in which an external apparatus different to the glasses-type terminal 10 and the information processing apparatus 30 recognizes a relative positional relationship between the display section 17 and the display section 31, and notifies the glasses-type terminal 10 and the information processing apparatus 30 of this positional relationship.

In this way, a display of information to these display sections can be controlled for the glasses-type terminal 10 and the information processing apparatus 30 according to the present embodiment, in accordance with a mutual relative positional relationship between the display sections, based on at least either a control of a display destination of the display information, or a control of a layout of the display information.

According to such a configuration, for example, in the case where a user observes the display section 31 through the display section 17, such as shown in FIG. 3, the display information displayed on each of the display sections 17 and 31 is integrated on the display section 31 side, and the display section 17 is controlled in a non-display state. In this way, by focusing on only the display section 31, it becomes possible for a user to observe the display information displayed on each of the display sections 17 and 31 on this display section 31. Further, since the information is integrated on the display section 31, it becomes possible to prevent the situation where the display information displayed on both of the display sections 17 and 31 is mutually superimposed, and it becomes difficult to distinguish each type of display information.

Heretofore, an outline of the information processing system 1 according to the present embodiment has been described with reference to FIG. 1 to FIG. 5. Note that, hereinafter, the glasses-type terminal 10 and the information processing apparatus 30 will be additionally described in detail.

### 2. HARDWARE CONIGURATION

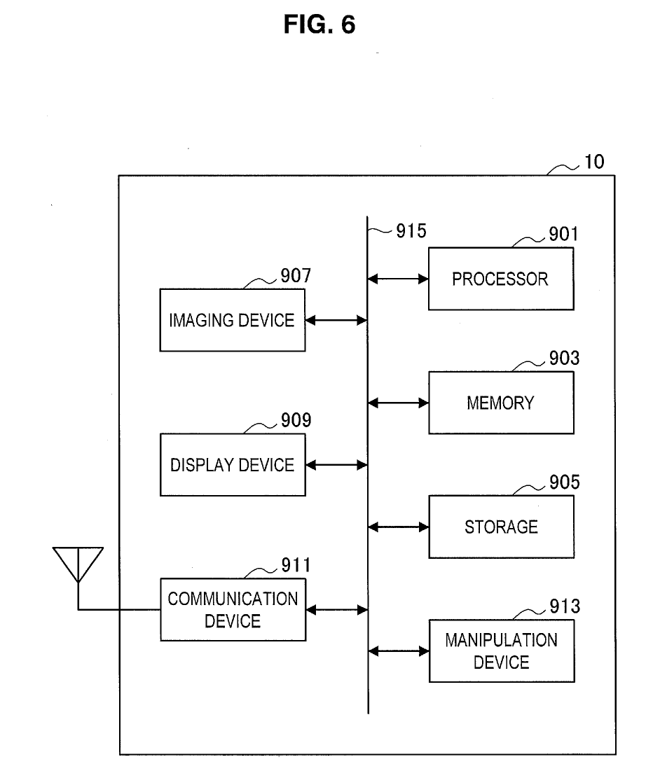

Next, an example of a hardware configuration of the glasses-type terminal 10 according to the present embodiment will be described with reference to FIG. 6. FIG. 6 is a diagram showing the example of the hardware configuration of the information processing device according to the present embodiment.

As shown in FIG. 6, the glasses-type terminal 10 according to the present embodiment includes a processor 901, a memory 903, a storage 905, an imaging device 907, a display device 909, and a bus 915. In addition, the glasses-type terminal 10 may include a communication device 911, a manipulation device 913, and an imaging device 907.

The processor 901 may be, for example, a central processing unit (CPU), a graphical processing unit (GPU), a digital signal processor (DSP), or a system on chip (SoC), which executes various processes of the glasses-type terminal 10. The processor 901 can be constituted by, for example, an electronic circuit for executing various arithmetic operation processes. The memory 903 includes a random access memory (RAM) and a read-only memory (ROM), which stores programs executed by the processor 901 and data. The storage 905 can include a storage medium such as a semiconductor memory or a hard disk.

The imaging device 907 has the function of capturing still images or dynamic images through a lens under the control of the processor 901. The imaging device 907 may cause the memory 903 or the storage 905 to store captured images.

The display device 909 is an example of an output device, which may be a display device such as a liquid crystal display (LCD) device, or an organic light emitting diode (OLED) display device. The display device 909 can provide information to user by displaying a screen.

Note that, when the lens portion of the glasses is configured as a display device as shown in FIG. 2, a transmissive-type display may be applied thereto as the display device 909.

The communication device 911 is a communication section of the glasses-type terminal 10, and communicates with an external device via a network. The communication device 911 is an interface for wireless communication, and may include a communication antenna, a radio frequency (RF) circuit, a baseband processor, and the like. As a specific example, the communication device 911 may be a communication device capable of establishing wireless communication with one or more information processing apparatuses 30 present within a prescribed communication area, such as Bluetooth (registered trademark).

The communication device 911 has the function of performing various kinds of signal processing on signals received from external devices, and can supply digital signals generated from received analog signals to the processor 901.

The manipulation device 913 has the function of generating input signals when a user performs a desired manipulation. The manipulation device 913 may be constituted by, for example, an input unit such as a button and a switch used by the user to input information, an input control circuit that generates input signals based on inputs made by the user and then supplies the signals to the processor 901.

The bus 915 causes the processor 901, the memory 903, the storage 905, the imaging device 907, the display device 909, the communication device 911, and the manipulation device 913 to be connected to one another. The bus 915 may include a plurality of kinds of buses.

### 3. FUNCTIONAL CONFIGURATION

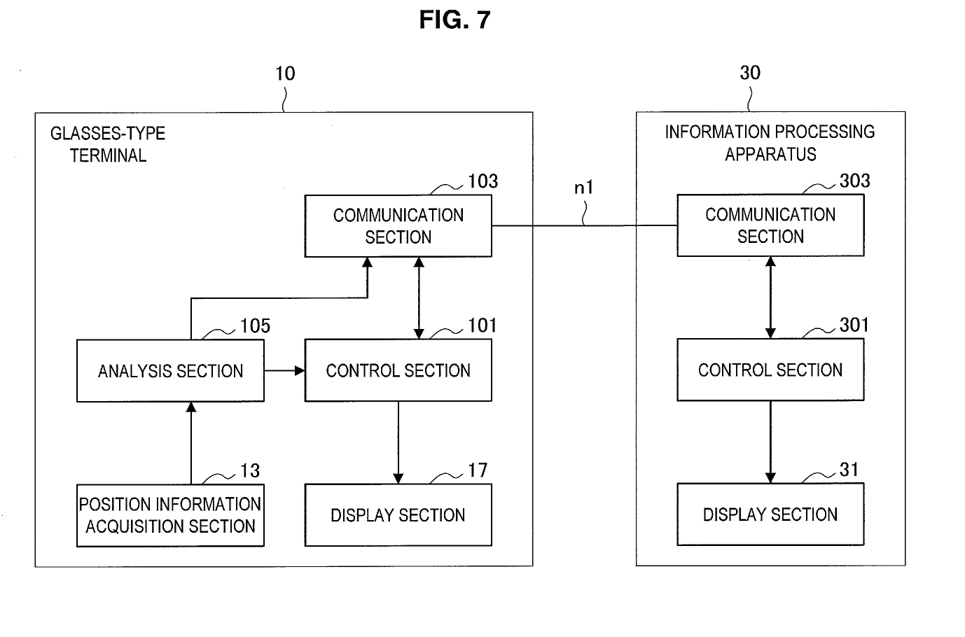

Next, an example of a schematic functional configuration of the glasses-type terminal 10 and the information processing apparatus 30, in the information processing system 1 according to the present embodiment, will be described with reference to FIG. 7. FIG. 7 is a block diagram which shows an example of a schematic functional configuration of the information processing system 1 according to the present embodiment.

First, a description will be made by focusing on the glasses-type terminal 10. As shown in FIG. 7, the glasses-type terminal 10 includes a control section 101, a communication section 103, an analysis section 105, a position information acquisition section 13, and a display section 17. Note that, a detailed description for the position information acquisition section 13 and the display section 17, which have been described above based on FIG. 2, will be omitted. Further, while an example is shown in FIG. 7 in which the glasses-type terminal 10 includes the position information acquisition section 13, it may be a configuration in which the position information acquisition section 13 (for example, an imaging section) is included external to this glasses-type terminal 10, as an external apparatus different to the glasses-type terminal 10.

The communication section 103 is an interface for the glasses-type terminal 10 to perform communication with the information processing apparatus 30. In particular, the communication section 103 according to the present embodiment is constituted to be capable of transmitting and receiving information via a network n1 with the information processing apparatus 30. Note that, for example, the network n1 is a wireless transmission line for connecting different devices, and a wireless communication network based on a Bluetooth (registered trademark) standard can be included as a specific example. The communication section 103 can be constituted, for example, by the communication device 911 shown in FIG. 6.

Note that, hereinafter, in the case where each of the elements within the glasses-type terminal 10 transmit and receive data with an external apparatus such as the information processing apparatus 30, the transmission and reception of data will be performed via the communication section 103, even in the case where there is no particular description.

The analysis section 105 corresponds to the above described information processing unit 11, acquires position information of the information processing apparatus 30 from the position information acquisition section 13, and specifies a relative positional relationship between the display section 17 and the display section 31, based on the acquired position information.

As a specific example, the analysis section 105 acquires an image captured by the position information acquisition section 13 constituted as an imaging section from this position information acquisition section 13. In this case, the analysis section 105 recognizes whether or not the information processing apparatus 30 is present in front of the glasses-type terminal 10, in accordance with whether or not the information processing apparatus 30 is captured within the acquired image. Then, in the case where the information processing apparatus 30 is present in front of the glasses-type terminal 10, the analysis section 105 specifies a relative position of the display section 31 with respect to the display section 17 of the glasses-type terminal 10, by the position, orientation and size of the display section 31 (or, the information processing apparatus 30 itself) within the image. In this way, it becomes possible for the analysis section 105 to specify a relative positional relationship between the display section 17 of the glasses-type terminal 10 and the display section 31 of the information processing apparatus 30.

Note that, it is needless to say that, in the case where the relative position of the display section 31 with respect to the display section 17 is specified based on a captured image, the position of the display section 17 itself is capable of being recognized in accordance with the positional relationship between the display section 17 and the position information acquisition section 13.

The analysis section 105 notifies the control section 101 and the information processing apparatus 30 of the relative position information which shows the relative positional relationship between the display section 17 and the display section 31. Note that, it is needless to say that, by having the relative position information specified in the information processing apparatus 30 notified, it becomes possible for the information processing apparatus 30 to recognize the relative positional relationship between the display section 17 and the display section 31, based on this relative position information.

The control section 101 acquires display information which becomes a display target, and controls a display of this display information to the display section 17. Note that, the acquisition source of the display information is not particularly limited. For example, the control section 101 may acquire display information which becomes a display target via an external network such as the internet. Further, the control section 101 may read data stored in a recording medium such as a portable medium, or a storage section (not illustrated) within the glasses-type terminal 10, and may cause display information based on this data to be displayed on the display section 17. Further, the control section 101 may acquire display information which becomes a display target from the information processing apparatus 30 via the network n1. Note that, the configuration which acquires display information in the control section 101 corresponds to the “acquisition section” in the glasses-type terminal 10.

Further, the control section 101 may acquire relative position information, which shows the relative positional relationship between the display section 17 and the display section 31, from the analysis section 105, and may control a display of information to the display section 17 based on this relative position information.

For example, in the case of the example shown in FIG. 3, in the case where the display section 31 is present within a prescribed region in front of the glasses-type terminal 10, the control section 101 may transmit display information which becomes a display target to the information processing apparatus 30, and may limit (for example, stop) a display of information to the display section 17.

Further, the control section 101 may subordinately execute a display of information of the display section 17 based on a control from the information processing apparatus 30 side. In the case of such a configuration, for example, in the case where display information which becomes a display target is acquired from the information processing apparatus 30, the control section 101 may be a configuration which outputs this acquired display information to the display section 17.

Note that, the control section 101 and the analysis section 105 can be constituted, for example, by the processor 901 shown in FIG. 6. Further, the display section 17 is capable of being constituted by the display device 909 shown in FIG. 6, and the position information acquisition section 13 is capable of being constituted, for example, by the imaging device 907 shown in FIG. 6.

Next, a description will be made by focusing on the information processing apparatus 30. As shown in FIG. 7, the information processing apparatus 30 includes a control section 301, a communication section 303, and a display section 31.

The communication section 303 is an interface for the information processing apparatus 30 to perform communication with the glasses-type terminal 10. In particular, the communication section 303 according to the present embodiment is constituted to be capable of transmitting and receiving data with the glasses-type terminal 10.

Note that, hereinafter, in the case where each of the elements within the information processing apparatus 30 transmit and receive data with an external apparatus such as the glasses-type terminal 10, the transmission and reception of data will be performed via the communication section 303, even in the case where there is no particular description.

The control section 301 acquires display information which becomes a display target, and controls a display of this display information to the display section 31. Note that, the point of the acquisition source of display information not being particularly limited is the same as the case of the glasses-type terminal 10. For example, the control section 301 may acquire display information which becomes a display target via an external network such as the internet. Further, the control section 301 may read data stored in a recording medium such as a portable medium, or a storage section (not illustrated) within the information processing apparatus 30, and may cause display information based on this data to be displayed on the display section 31. Further, the control section 301 may acquire display information which becomes a display target from the glasses-type terminal 10 via the network n1. Note that, the configuration which acquires display information in the control section 301 corresponds to the “acquisition section” in the information processing apparatus 30.

Further, the control section 301 may acquire relative position information, which shows the relative positional relationship between the display section 17 and the display section 31, from the glasses-type terminal 10, and may control a display of information to the display section 31 based on this relative position information.

For example, in the case of the example shown in FIG. 3, in the case where the display section 31 is present within a prescribed region in front of the glasses-type terminal 10, the control section 301 acquires display information from this glasses-type terminal 10. Then, the control section 301 integrates the display information displayed on the display section 31 and the display information acquired from the glasses-type terminal 10, and causes the integrated display information to be displayed on the display section 31. Note that, in this case, by changing a layout of the display information displayed on the display section 31, the control section 301 may secure a region for displaying the display information acquired from the glasses-type terminal 10.

Further, the control section 101 may include a holding section for holding backup information for restoring a state in which the display information is displayed on the display section 17 prior to coordination with the information processing apparatus 30. Note that, the display information displayed on the display section 17, setting information for controlling a display mode of this display information (for example, magnification ratio, type of font, display color, luminance setting of the display section or the like) or the like can be included as backup information.

In this case, when coordination with the information processing apparatus 30 is started and a display of display information to the display section 17 is limited, the control section 101 may record backup information for restoring a state prior to coordination to the holding section. Based on such a configuration, in the case where coordination with the information processing apparatus 30 has ended, the control section 101 may restore a state prior to coordination based on the backup information held in the holding section.

Note that, the above described configurations related to the holding of backup information and the restoration of this backup information are the same for the control section 301 of the information processing apparatus 30 side.

Heretofore, an example of a schematic functional configuration of the glasses-type terminal 10 and the information processing apparatus 30, in the information processing system 1 according to the present embodiment, has been described with reference to FIG. 7.

### 4. PROCESSES

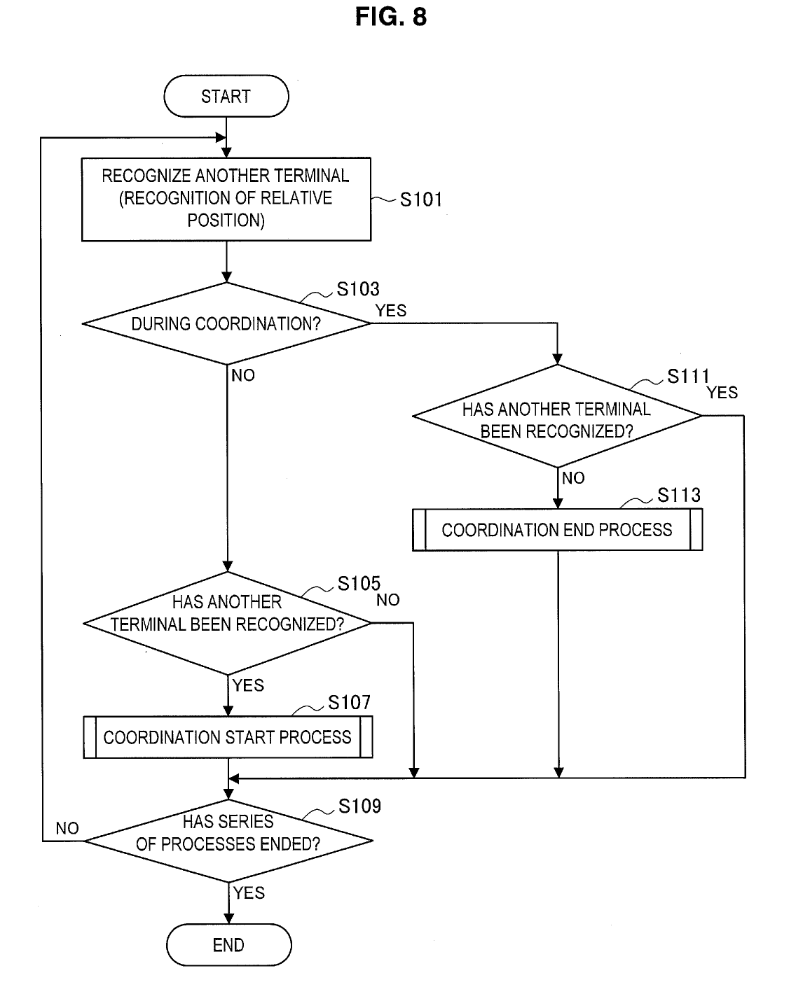

Next, an example of the flow of a series of processes related to the start and end of coordination between the glasses-type terminal 10 and the information processing apparatus 30, in the information processing system 1 according to the present embodiment, will be described with reference to FIG. 8 to FIG. 10. Note that, in the present disclosure, each of the glasses-type terminal 10 and the information processing apparatus 30 will be described as individually and independently controlling the display sections (that is, the display section 17 and the display section 31) respectively included within (that is, the control subject of each display section is included in the apparatus in which this display section is included).

### 4.1. Process Related to the Start and End of Coordination

First, a description will be made, for the flow of all the processes related to the start and end of coordination between the glasses-type terminal 10 and the information processing apparatus 30, by focusing on the operations of the side which recognizes the relative position of the information processing apparatus of the coordination destination, that is, the glasses-type terminal 10 side. FIG. 8 is a flow chart which shows an example of the processes related to coordination between the glasses-type terminal 10 and the information processing apparatus 30 according to the present embodiment.

(Step S101)

First, the glasses-type terminal 10 confirms whether or not the information processing apparatus 30 which is a coordination target is present in front of this glasses-type terminal 10, based on position information acquired by the position information acquisition section 13. Note that, in the case where the presence of the information processing apparatus 30 has been recognized, the glasses-type terminal 10 recognizes a relative positional relationship between the display section 17 of this glasses-type terminal 10 and the display section 31 of this information processing apparatus 30.

(Step S103)

The glasses-type terminal 10 controls a coordination state with this information processing apparatus 30, in accordance with whether or not the information processing apparatus 30 has been recognized and whether or not coordination with this information processing apparatus 30 has been established.

(Step S 105)

For example, in the case where coordination between the glasses-type terminal 10 and the information processing apparatus 30 has not been established (step 103, NO), the glasses-type terminal 10 determines whether or not to establish coordination with this information processing apparatus 30, in accordance with whether or not the information processing apparatus 30 has been recognized.

(Step S107)

In the case where the information processing apparatus 30 has been recognized (step S105, YES), the glasses-type terminal 10 establishes communication with this information processing apparatus 30, and starts coordination with this information processing apparatus 30 via the established communication. Note that, it is needless to say that, in the case where communication with the information processing apparatus 30 has already been established, the processes related to the establishment of this communication may not be executed. Further, the details of the processes related to the start of coordination between the glasses-type terminal 10 and the information processing apparatus 30 will be separately described later. Note that, it is needless to say that, in the case where the information processing apparatus 30 has not been recognized (step S105, NO), coordination with the information processing apparatus 30 is not established for the glasses-type terminal 10.

(Step S111)

Next, the case where coordination between the glasses-type terminal 10 and the information processing apparatus 30 has been established (step S103, YES) will be described. In this case, the glasses-type terminal 10 determines whether or not to end coordination with this information processing apparatus 30, in accordance with whether or not the information processing apparatus 30 has been recognized.

(Step S113)

While the information processing apparatus 30 is recognized (step S111, YES), the glasses-type terminal 10 maintains coordination with the information processing apparatus 30. Further, in the case where the information processing apparatus 30 has not been recognized (step S111, NO), the glasses-type terminal 10 ends coordination with the information processing apparatus 30. Note that, the details of the processes related to the end of coordination between the glasses-type terminal 10 and the information processing apparatus 30 will be separately described later.

(Step S109)

As described above, the glasses-type terminal 10 successively observes a relative positional relationship between the display section 17 and the display section 31, up until when an end of the series of process (for example, stopping of the glasses-type terminal 10 or the like) is instructed (step S109, NO), and controls a coordination state with the information processing apparatus 30 in accordance with this positional relationship. In the case where an end of the series of processes has been instructed (step S109, YES), the glasses-type terminal 10 ends the observation of a relative positional relationship between the display section 17 and the display section 31, and the processes related to the control of a coordination state with this information processing apparatus 30.

### 4.2. Processes at the Time of a Coordination Start

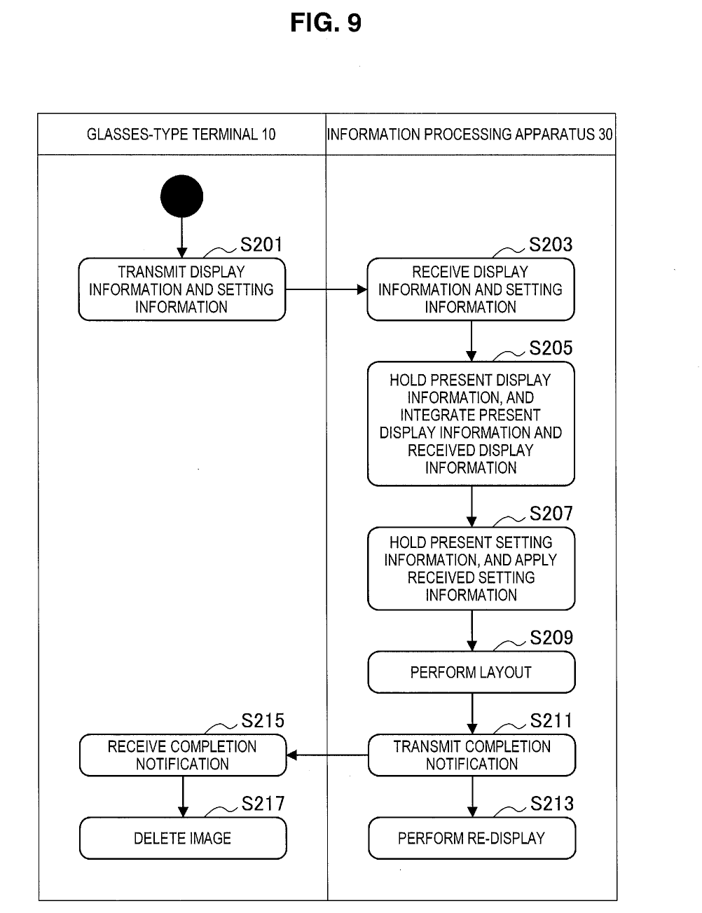

Next, a detailed example of the processes related to the start of coordination between the glasses-type terminal 10 and the information processing apparatus 30 will be described with reference to FIG. 9. FIG. 9 is an activity diagram which shows an example of the processes related to the start of coordination between the glasses-type terminal 10 and the other information processing apparatus 30 according to the present embodiment.

(Step S201)

When the information processing apparatus 30 which becomes a coordination target is recognized based on position information from the position information acquisition section 13, the glasses-type terminal 10 transmits display information held as a display target, and setting information related to the control of a display mode (for example, a magnification ratio) of this display information, to this information processing apparatus 30. Note that, at this time, the glasses-type terminal 10 may hold the display information and setting information at the time of a coordination end in a holding section (not illustrated) as backup information.

(Step S203)

The information processing apparatus 30 receives the display information which becomes a display target, and the setting information related to the control of a display mode of this display information, from the glasses-type terminal 10.

(Step S205)

The information processing apparatus 30 holds the display information displayed on the display section 31 in the holding section (not illustrated) as backup information so as to be able to perform restoration after a coordination end. Then, the information processing apparatus 30 integrates the display information received from the glasses-type terminal 10, and the display information displayed on the display section 31.

(Step S207)

Further, the information processing apparatus 30 holds the setting information related to the control of a display mode of the display information displayed on the display section 31 in the holding section (not illustrated) as backup information so as to be able to perform restoration after a coordination end. Then, the information processing apparatus 30 changes the display mode of the display information displayed on the display section 31, by applying the setting information received from the glasses-type terminal 10. In this way, for example, the magnification ratio of the display information displayed on the display section 31 is changed based on the magnification ratio set at the glasses-type terminal 10 side.

(Step S209)

Note that, in the case where the integrated display information is displayed on the display section 31, the information processing apparatus 30 may change the layout of the display information displayed on the display section 31, in order to secure a region to display the newly added display information, by a change of the display mode and integration of the display information. Further, at this time, the information processing apparatus 30 may hold the setting information for restoring the layout prior to a change in the holding section (not illustrated) as backup information.

(Step S211)

When the above described series of controls for starting coordination of a display of display information, such as the integration of display information, the updating of a display mode and the changing of the layout, is completed, the information processing apparatus 30 transmits a completion notification, which shows a completion of controls for a coordination start, to the glasses-type terminal 10.

(Step S213)

When the transmission of the completion notification to the glasses-type terminal 10 is completed, the information processing apparatus 30 causes the integrated display information to be displayed on the display section 31.

(Step S215)

The glasses-type terminal 10 receives the completion notification, which shows a completion of controls for a coordination start, from the information processing apparatus 30.

(Step S217)

When the completion notification is received, the glasses-type terminal 10 limits a display of the display information to the display section 17. According to the above description, coordination between the glasses-type terminal 10 and the other information processing apparatus 30 is established.

### 4.3. Processes at the Time of a Coordination End

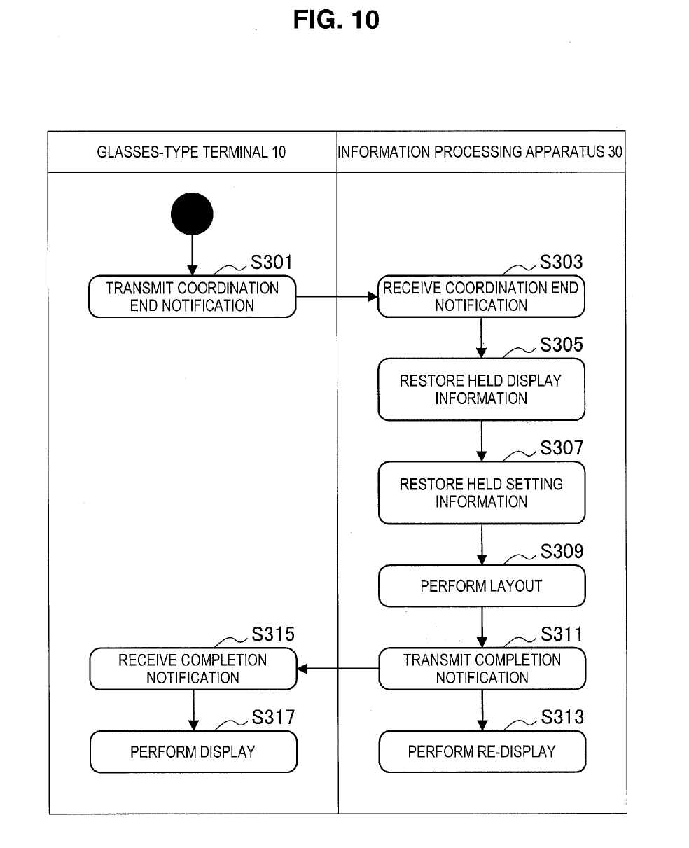

Next, a detailed example of the processes related to the end of coordination between the glasses-type terminal 10 and the information processing apparatus 30 will be described with reference to FIG. 10. FIG. 10 is an activity diagram which shows an example of the processes related to the end of coordination between the glasses-type terminal 10 and the other information processing apparatus 30 according to the present embodiment.

(Step S301)

When it is recognized that the information processing apparatus 30 is not present in front of this glasses-type terminal 10, based on position information from the position information acquisition section 13, in a state where coordination with the information processing apparatus 30 has been established, the glasses-type terminal 10 transmits a coordination end notification to the information processing apparatus 30.

(Step S303)

The information processing apparatus 30 receives the coordination end notification from the glasses-type terminal 10.

(Step S305)

When the coordination end notification is received, the information processing apparatus 30 restores the display information displayed on the display section 31 prior to coordination, based on backup information held in the holding section (not illustrated).

(Step S307)

Similarly, the information processing apparatus 30 restores a display mode of the display information displayed on the display section 31 prior to coordination (that is, restores the setting information), based on backup information held in the holding section (not illustrated). In this way, for example, the magnification ratio of the display information displayed on the display section 31 is changed to the magnification ratio of the display information prior to coordination.

(Step S309)

Further, the information processing apparatus 30 may change the layout of display information to be displayed on the display section 31, in accordance with the restoration of the display information or the display mode. Further, in the case where backup information related to the restoration of the layout is held in the holding section (not illustrated), the information processing apparatus 30 may restore the layout of the display information prior to coordination based on this backup information.

(Step S311)

When the above described series of controls for ending coordination of a display of display information, such as the restoration of the display information, the display mode or the layout, is completed, the information processing apparatus 30 transmits a completion notification, which shows a completion of controls for a coordination end, to the glasses-type terminal 10.

(Step S313)

When the transmission of the completion notification to the glasses-type terminal 10 is completed, the information processing apparatus 30 causes the restored display information to be displayed on the display section 31.

(Step S315)

The glasses-type terminal 10 receives the completion notification, which shows a completion of controls for a coordination end, from the information processing apparatus 30.

(Step S317)

When the completion notification is received, the glasses-type terminal 10 restores the display information displayed on the display section 17 prior to coordination, based on backup information held in the holding section (not illustrated). Then, the glasses-type terminal 10 causes the restored display information to be displayed on the display section 17. According to the above description, coordination between the glasses-type terminal 10 and the other information processing apparatus 30 ends.

Note that, the above described series of operations can be constituted by a program for causing a CPU of an apparatus operating each of the elements of the glasses-type terminal 10 and the information processing apparatus 30 to function. This program may be constituted so as to be executed via an Operating System (OS) installed in this apparatus. Further, the stored position will not be limited, if this program is capable of being read by an apparatus in which elements for executing the above described process are included. For example, the program may be stored in a recording medium connected externally from the apparatus. In this case, it may be constituted, by connecting a recording medium in which the program is stored to an apparatus, so as to cause a CPU of this apparatus to execute this program.

### 5. MODIFIED EXAMPLES

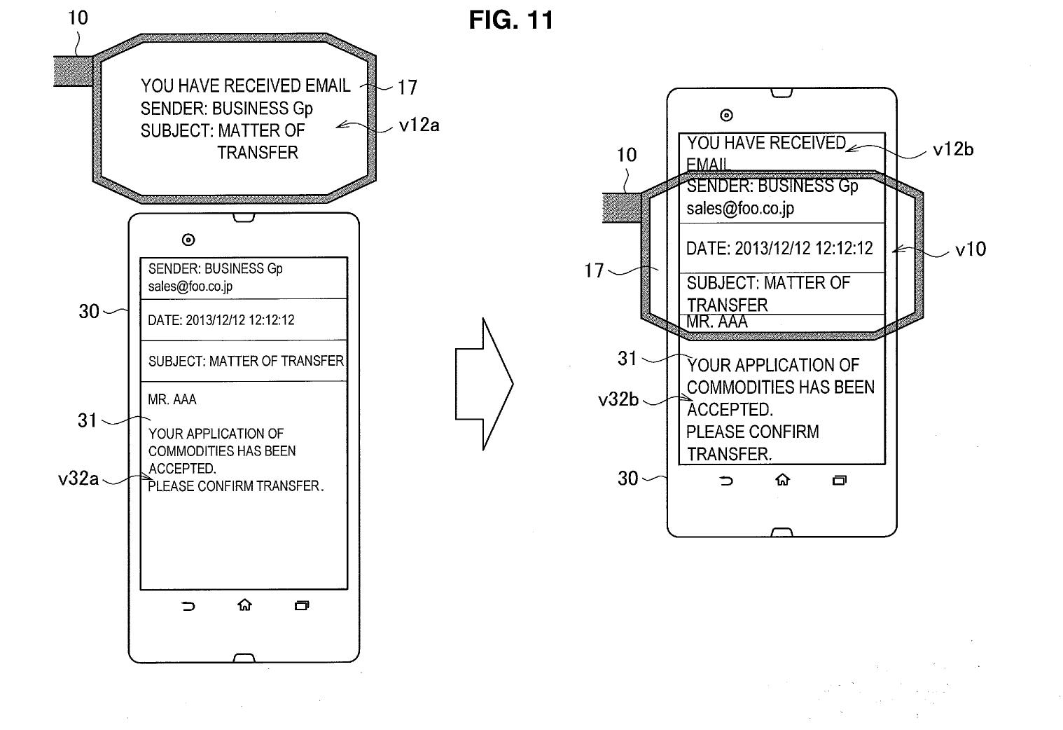

Next, modified examples of the information processing system 1 according to the present embodiment will be respectively described with reference to FIG. 11 to FIG. 14.

### 5.1. First Modified Example

First, the information processing system 1 according to a first modified example will be described with reference to FIG. 11. FIG. 11 is an explanatory diagram for describing an outline of the information processing system 1 according to the first modified example.

FIG. 11 shows an example of the case where the magnification ratio of display information displayed on the display section 31 is controlled, in accordance with a relative positional relationship between the display section 17 of the glasses-type terminal 10 and the display section 31 of the information processing apparatus 30.

For example, the left side of FIG. 11 shows a state in which the display section 31 of the information processing apparatus 30 is not present within the visual field of a user via the display section 17 of the glasses-type terminal 10 constituted as a transmissive-type display. At this time, display information v12a is displayed on the display section 17, display information v32a is displayed on the display section 31, and the display information v12a and the display information v32a are each displayed with different magnification ratios.

Further, the right side of FIG. 11 shows a state in which a user observes the display section 31 through the display section 17, in other words, a state in which the display section 31 is present within a prescribed region of a direction of an opposite side to a direction the display section 17 presents display information towards the user. In this case, mutual coordination is performed between the glasses-type terminal 10 and the information processing apparatus 30 according to the first modified example similar to the example described based on FIG. 3, the display information displayed on each of the display sections is integrated and displayed on one of the display sections, and a display of information is limited for the other display section.

For example, in the case of the example shown on the right side of FIG. 11, the display information v12a displayed on the display section 17 is displayed on the display section 31 by being integrated with the display information v31b displayed on the display section 31 as display information v12b.

Further, as shown on the right side of FIG. 11, the information processing apparatus 30 receives setting information showing the magnification ratio from this glasses-type terminal 10 at the time of coordination with the glasses-type terminal 10, and controls the magnification ratio of the display information v12b and v32b to be displayed on the display section 31 based on the received magnification ratio.

According to the configuration such as described above, in the information processing system 1 according to the first modified example, the magnification ratio set on the glasses-type terminal 10 side is automatically reflected on the information processing apparatus 30 side, at the time of coordination between the glasses-type terminal 10 and the information processing apparatus 30. Accordingly, it becomes possible for a user to refer to the information displayed on the information processing apparatus 30 side, with a same magnification ratio as the information displayed on the display section 17 of the glasses-type terminal 10, without performing complicated operations for the information processing apparatus 30 side.

Note that, while the case where the magnification ratio is controlled has been described above as an example, the target of control will not be necessarily limited to the magnification ratio, if there are parameters related to a display mode for displaying information to each of the display sections. For example, the type of font of information displayed on each of the display sections, a setting of the display color, a setting of the luminance of the display sections or the like may be set as a control target.

### 5.2. Second Modified Example

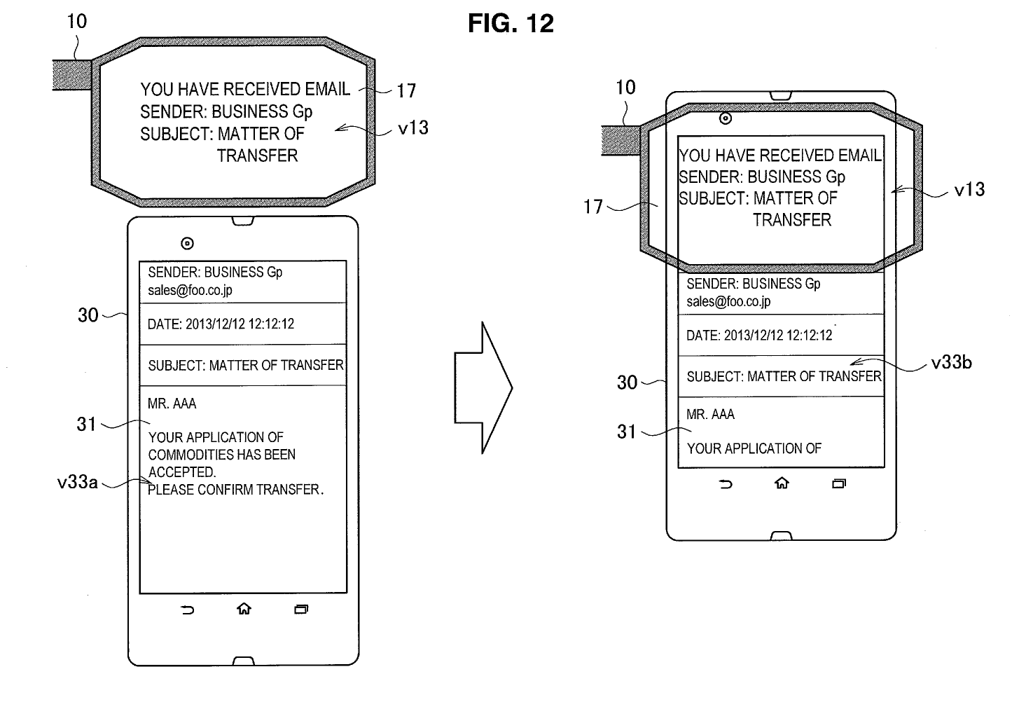

Next, the information processing system 1 according to a second modified example will be described with reference to FIG. 12. FIG. 12 is an explanatory diagram for describing an outline of the information processing system 1 according to the second modified example. In the information processing system 1 according to the above described embodiment, an example has been described which integrates the display information displayed on the display section 17 of the glasses-type terminal 10 and the display information displayed on the display section 31 of the information processing apparatus 30. In the second modified example, an example will be described in the case where only the layout of display information is controlled, so that the display information mutually displayed on the display sections is not superimposed, without an integration of display information being performed between the glasses-type terminal 10 and the information processing apparatus 30.

For example, the left side of FIG. 12 shows a state in which the display section 31 of the information processing apparatus 30 is not present within the visual field of a user via the display section 17 of the glasses-type terminal 10 constituted as a transmissive-type display. At this time, display information v13 is displayed on the display section 17, and display information v33a is displayed on the display section 31.

Further, the right side of FIG. 12 shows a state in which a user observes the display section 31 through the display section 17. In this case, the information processing apparatus 30 recognizes a relative positional relationship between this glasses-type terminal 10 and this information processing apparatus 30 based on relative position information notified from the glasses-type terminal 10. Then, the information processing apparatus 30 specifies a region on the display section 31 which the user observes through the display section 17, and changes the layout of the display information displayed on the display section 31 so that information is not displayed on the specified region.

For example, the example shown on the right side of FIG. 12 shows the case where a user refers to a region on the upper side of the display section 31 through the display section 17. In this case, the information processing apparatus 30 specifies the region on the upper side of the display section 31 as a region on the display section 31 which the user is observing through the display section 17, based on the relative positional relationship between the glasses-type terminal 10 and the information processing apparatus 30. Then, the information processing apparatus 30 changes the layout of the display information displayed on the display section 31, so that information is not displayed on the region of the upper side of the display section 31, as shown in the reference numeral v33b.

Further, the information processing apparatus 30 may control the region on the display section 31 which the user observes through the display section 17, by dividing into a region which further limits a display of information and a region which displays information. For example, in the case where display information is displayed on only a part of the region, out of the display section 17 of the glasses-type terminal 10, the information processing apparatus 30 may be controlled so that this display information is not superimposed with the display information displayed on the display section 31 side.

Specifically, the glasses-type terminal 10 may additionally notify the information processing apparatus 30 of position information, which shows the position at which the display information is displayed in the display region of the display section 17, in addition to the relative position information which shows the relative position of the information processing apparatus 30 with respect to this glasses-type terminal 10. In this way, it becomes possible for the information processing apparatus 30 to further specify a region on the display section 31 corresponding to the region on which the display information is displayed at the display section 17 side, out of the region on the display section 31 which the user observes through the display section 17. Accordingly, it becomes possible for the information processing apparatus 30 to perform a control so as to display the display information, for the region on the display section 31 corresponding to the region on which display information is not displayed at the display section 17 side, even if in the region on the display section 31 which the user observes through the display section 17.

Heretofore, as described as the second modified example, the information processing system 1 may be constituted so as to control only the layout of display information, so that the display information mutually displayed on the display sections is not superimposed, without an integration of display information being performed between the glasses-type terminal 10 and the information processing apparatus 30. Note that, it is needless to say that, in the case where the glasses-type terminal 10 and the information processing apparatus 30 coordinate, such as in the information processing system 1 according to the first modified example, the information processing system 1 according to the second modified example may control the magnification ratio of the display information of the information processing apparatus 30 side.

### 5.3. Third Modified Example

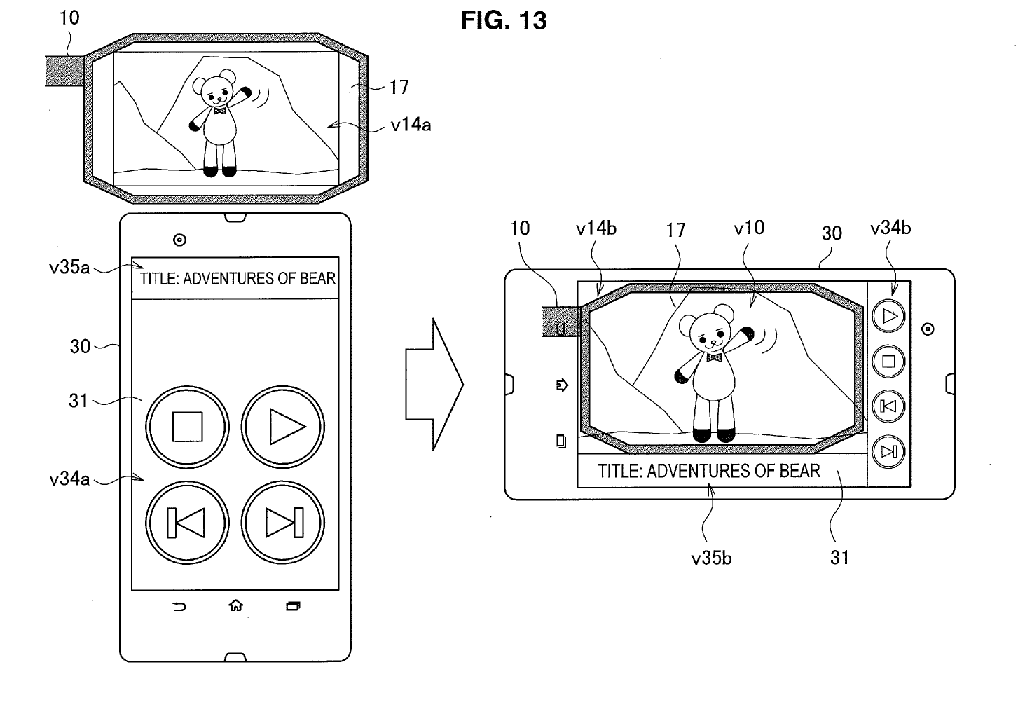

Next, the information processing system 1 according to a third modified example will be described with reference to FIG. 13. FIG. 13 is an explanatory diagram for describing an outline of the information processing system 1 according to the third modified example.

For example, in the case where the glasses-type terminal 10 and the information processing apparatus 30 are individually and independently operated, and in the case where the display section 31 of the information processing apparatus 30 is referred to through the display section 17 of the glasses-type terminal 10, there will be cases where the use scenes are different. For example, the example shown in FIG. 13 shows the case where controls related to the display of image content v14a, attribute information v35a (for example, a title or the like) of this image content, and an interface v34a for operating this image content, are coordinated between the glasses-type terminal 10 and the information processing apparatus 30.

The left side of FIG. 13 shows a state in which the display section 31 of the information processing apparatus 30 is not present within the visual field of a user via the display section 17 of the glasses-type terminal 10 constituted as a transmissive-type display. In this case, the display section 17 is used as a display region for displaying the image content v14a, and the display section 31 is used as a display region for displaying the attribute information v35a and the interface v34a. In this way, by having the attribute information v35a and the interface v34a displayed on the display section 31 side, it becomes possible for the image content v14a to be displayed as large as possible on the display section 17.

On the other hand, the right side of FIG. 13 shows a state in which a user observes the display section 31 through the display section 17. At this time, the information processing apparatus 30 integrates the image content v14a, the attribute information v35a and the interface v34a, such as in the above described embodiment, and displays the integrated information on the display section 31 side, and the glasses-type terminal 10 limits a display of information to the display section 17 such as shown in the reference numeral v10.

In this way, in the example shown on the right side of FIG. 13, the use scene is different to that of the example shown on the left side of FIG. 13, the information processing apparatus 30 performs a display so that the image content v14a is emphasized, and it may be also necessary to present the attribute information v35a and the interface v34a.

Accordingly, in the case where the display information displayed on both of the display sections 17 and 31 is integrated, the information processing apparatus 30 may arbitrarily switch the layout at the time of integration, in accordance with the type of display information (for example, type of content) which becomes a target. For example, in the example shown on the right side of FIG. 13, the information processing apparatus 30 changes the layout so that the attribute information v35a and the interface v34a are displayed with a minimum size on the edge of the display region of the display section 31, such as shown in the reference numerals 34b and 35b. According to such a process, the information processing apparatus 30 presents the attribute information v35a and the interface v34a, and it becomes possible to secure a region as large as possible, in order to display the image content v14a, such as shown in the reference numeral v14b.

Note that, the example shown in FIG. 13 is merely an example, and how the layout of the display information displayed on the display sections 17 and 31 is controlled, before and after coordination between the glasses-type terminal 10 and the information processing apparatus 30, may be arbitrarily controlled in accordance with an expected use scene.

Heretofore, as described as the third modified example, in the case where the glasses-type terminal 10 and the information processing apparatus 30 are individually and independently operated, and in the case where the display section 31 of the information processing apparatus 30 is referred to through the display section 17 of the glasses-type terminal 10, there will be cases where the use scenes are different. Accordingly, in the case where the use scenes are different before and after coordination between the glasses-type terminal 10 and the information processing apparatus 30, the glasses-type terminal 10 or the information processing apparatus 30 may change the layout of the case where display information is to be displayed to each of the display sections in accordance with a use scene. According to such a configuration, it becomes possible for the information processing system 1 according to the third modified example to present a user with each type of display information with an arbitrarily easily viewed layout, in accordance with the type of content which becomes a display target or the use scenes of the glasses-type terminal 10 and the information processing apparatus 30 for displaying this content.

### 5.4. Fourth Modified Example

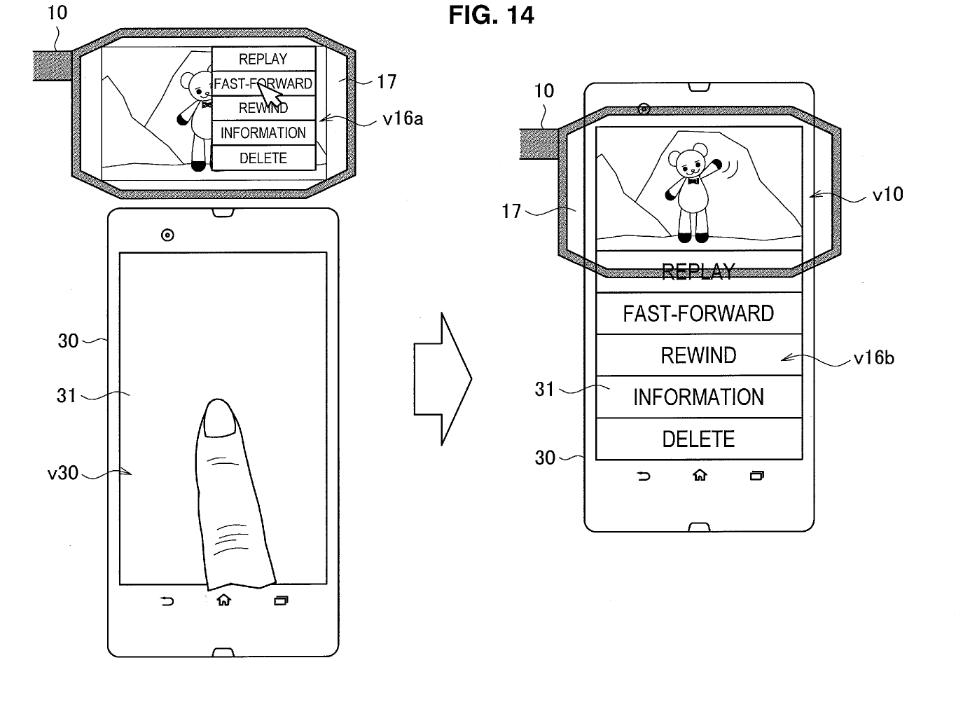

Next, the information processing system 1 according to a fourth modified example will be described with reference to FIG. 14. FIG. 14 is an explanatory diagram for describing an outline of the information processing system 1 according to the fourth modified example. The example shown in FIG. 14 shows an example of the case where the use scenes are different, in the case where the glasses-type terminal 10 and the information processing apparatus 30 are individually and independently operated, and in the case where the display section 31 of the information processing apparatus 30 is referred to through the display section 17 of the glasses-type terminal 10.

The left side of FIG. 14 shows a state in which the display section 31 of the information processing apparatus 30 is not present within the visual field of a user via the display section 17 of the glasses-type terminal 10 constituted as a transmissive-type display. In this case, the display section 17 is used as a display region for displaying image content, and an operation menu and pointer for operating this image content, such as shown in the reference numeral v16a. Further, the portion corresponding to a touch panel of the display section 31 is used as a pad for operating this pointer.

Further, the right side of FIG. 14 shows a state in which a user observes the display section 31 through the display section 17. In this case, the information processing apparatus 30 switches a display destination of the image content and the operation menu displayed on the display section 17 to the display section 31, and the glasses-type terminal 10 limits a display of information to the display section 17 such as shown in the reference numeral v10. Further, in this case, the information processing apparatus 30 switches the display section 31 from an operation as a pad to an operation as a touch panel, and limits a display of the pointer.

Further, at the time when the display destination of the display section 31 for the image content and the operation menu is switched to the display section 31, the information processing apparatus 30 may change the layout of the image content and the operation menu in accordance with the orientation and image size of the display section 31, such as shown in the reference numeral v16b.

As describe above, in the case where the glasses-type terminal 10 and the information processing apparatus 30 are individually and independently operated, and in the case where the display section 31 of the information processing apparatus 30 is referred to through the display section 17 of the glasses-type terminal 10, there will be cases in which it is desirable to change an operation state in accordance with differences of the use scenes.

In contrast to this, in the information processing system 1 according to the fourth modified example, the display destination and layout of the display information is changed, before and after coordination between the glasses-type terminal 10 and the information processing apparatus 30, and an operation state for using the operation interface (for example, the portion corresponding to a touch panel of the display section 31) is arbitrarily switched. According to such a configuration, it becomes possible for the information processing system 1 according to the fourth modified example to present a user with an operation interface which is easy to perform arbitrary operations, in accordance with the type of content which becomes a display target or the use scenes of the glasses-type terminal 10 and the information processing apparatus 30 for displaying this content.

### 6. SUMMARY

As described heretofore, a display of information to each of the display sections is controlled for the glasses-type terminal 10 and the information processing apparatus 30 according to the present embodiment, in accordance with a mutual relative positional relationship between the display sections, based on at least either a control of a display destination of display information, or a control of a layout of the display information.

According to such a configuration, in the case where a user observes the display section 31 through the display section 17, it becomes possible for the information processing system 1 according to the present embodiment to integrate the display information displayed on each of the display sections 17 and 31 to the display section 31 side, and to control the display section 17 in a non-display state. In this way, by focusing on only the display section 31, it becomes possible for the user to observe the display information displayed on each of the display sections 17 and 31 on this display section 31.

Further, in accordance with the integration of information to the display section 31 and a change of the layout of display information displayed on the display section 31, it becomes possible to prevent the situation where the display information displayed on both of the display sections 17 and 31 is mutually superimposed, and it becomes difficult to distinguish each type of display information.

Note that, in the above described examples, examples have been described in which one of the mutually coordinating information processing apparatuses is constituted as a glasses-type terminal. However, it is needless to say that this information processing apparatus will not be necessarily limited to a glasses-type terminal, if this information processing apparatus incudes a display section constituted as a transmissive-type display.

It should be understood by those skilled in the art that various modifications, combinations, sub-combinations and alterations may occur depending on design requirements and other factors insofar as they are within the scope of the appended claims or the equivalents thereof.

In addition, the effects described in the present specification are merely illustrative and demonstrative, and not limitative. In other words, the technology according to the present disclosure can exhibit other effects that are evident to those skilled in the art along with or instead of the effects based on the present specification.

Additionally, the present technology may also be configured as below.
(1) An information processing apparatus, including:

an information acquisition section which acquires display information; and

a first display section which displays the display information,

wherein a display of the display information is controlled for the first display section, in accordance with a relative positional relationship between the first display section and a second display section provided in an external apparatus, based on at least one of a control of a display destination of the display information between the first display section and the second display section, and a control of a layout of the display information displayed on the first display section.
(2) The information processing apparatus according to (1),

wherein the first display section is a transmissive-type display device, and

wherein a display of the display information is controlled for the first display section, in accordance with a relative positional relationship of the second display section on an opposite side to a direction the first display section presents the display information towards a user, based on at least one of a control of a display destination of the display information and a control of the layout.
(3) The information processing apparatus according to (2),

wherein, in the case where the second display section is positioned within a prescribed region on an opposite side to a direction the first display section presents the display information towards a user, the first display section is controlled so a display of at least a part of display information out of the display information is limited.
(4) The information processing apparatus according to (2) or (3),

wherein the first display section includes a holding section which holds the first display section on the head of the user so as to be held in front of the eyes of the user.
(5) The information processing apparatus according to (1),

wherein the information processing apparatus is an information processing apparatus which operates by coordinating with the external apparatus including the second display section constituted as a transmissive-type display device, and

wherein a display of the display information is controlled for the first display section, in accordance with a relative positional relationship of the first display section with respect to the second display section on an opposite side to a direction the second display section presents the display information towards a viewer, based on at least one of a control of a display destination of the display information and a control of the layout.
(6) The information processing apparatus according to (5),

wherein, in the case where the first display section is positioned within a prescribed region on an opposite side to a direction the second display section presents the display information towards a user, the first display section is controlled so at least a part of display information out of the display information displayed on the second display section is displayed.
(7) The information processing apparatus according to (6),

wherein the first display section is controlled so as to display display information in which the display information displayed on the first display section, and at least a part of display information out of the display information displayed on the second display section, are integrated.
(8) The information processing apparatus according to (5) or (6),

wherein a display of the display information is controlled for the first display section, in accordance with a relative positional relationship of the first display section with respect to the second display section, based on a control which changes a layout of the display information.
(9) The information processing apparatus according to (8),

wherein a display of the display information is controlled for the first display section, in accordance with a display position of display information displayed on the second display section, based on a control which changes a layout of display information displayed on the first display section.
(10) The information processing apparatus according to any one of (5) to (9),

wherein a display of the display information is controlled for the first display section, in accordance with a relative positional relationship of the first display section with respect to the second display section, and a display mode of the display information on the second display section, based on a control which changes a display mode of the display information displayed on the first display section.
(11) The information processing apparatus according to (10),

wherein a display of the display information is controlled for the first display section, in the case where the first display section is positioned within a prescribed region on an opposite side to a direction the second display section presents the display information towards a user, so a display mode of the display information displayed on the first display section changes based on a display mode of the display information on the second display section.
(12) The information processing apparatus according to (10) or (11),

wherein a display of the display information is controlled for the first display section based on a control which changes a magnification ratio of the display information as the display mode.
(13) The information processing apparatus according to any one of (1) to (12), further including:

a control section which executes, in accordance with a relative positional relationship between the first display section and the second display section, at least one of a control of a display destination of the display information and a control of the layout.
(14) The information processing apparatus according to (13), further including:

a position information acquisition section which acquires position information showing a relative positional relationship between the first display section and the second display section,

wherein the control section executes at least one of a control of a display destination of the display information and a control of the layout, based on the acquired position information.
(15) An information processing method, including:

acquiring display information;

displaying, by a processor, the display information on a first display section; and

controlling a display of the display information to the first display section, in accordance with a relative positional relationship between the first display section and a second display section provided in an external apparatus, based on at least one of a control of a display destination of the display information between the first display section and the second display section, and a control of a layout of the display information displayed on the first display section.
(16) An information processing system, including:

a first information processing apparatus including a first display section;

a second information processing apparatus including a second display section; and

a control section which controls, in accordance with a relative positional relationship between the first display section and the second display section, at least one of a display destination of display information between the first display section and the second display section, and a layout of the display information displayed on the first display section.
(17) An information processing apparatus, including:

an information acquisition section which acquires display information; and

a control section which controls, in accordance with a relative positional relationship between a first display section and a second display section provided in a different apparatus to the first display section, at least one of a display destination of the display information between the first display section and the second display section, and a layout of the display information displayed on the first display section.

What is claimed is:

1. An information processing apparatus, comprising:
an information acquisition section which acquires display information; and
a first display section which displays the display information,
wherein a display of the display information is controlled for the first display section, in accordance with a relative positional relationship between the first display section and a second display section provided in an external apparatus, based on at least one of a control of a display destination of the display information between the first display section and the second display section, and a control of a layout of the display information displayed on the first display section.

2. The information processing apparatus according to claim 1,
wherein the first display section is a transmissive-type display device, and
wherein a display of the display information is controlled for the first display section, in accordance with a relative positional relationship of the second display section on an opposite side to a direction the first display section presents the display information towards a user, based on at least one of a control of a display destination of the display information and a control of the layout.

3. The information processing apparatus according to claim 2,
wherein, in the case where the second display section is positioned within a prescribed region on an opposite side to a direction the first display section presents the display information towards a user, the first display section is controlled so a display of at least a part of display information out of the display information is limited.

4. The information processing apparatus according to claim 2,
wherein the first display section includes a holding section which holds the first display section on the head of the user so as to be held in front of the eyes of the user.

5. The information processing apparatus according to claim 1,
wherein the information processing apparatus is an information processing apparatus which operates by coordinating with the external apparatus including the second display section constituted as a transmissive-type display device, and
wherein a display of the display information is controlled for the first display section, in accordance with a relative positional relationship of the first display section with respect to the second display section on an opposite side to a direction the second display section presents the display information towards a viewer, based on at least one of a control of a display destination of the display information and a control of the layout.

6. The information processing apparatus according to claim 5,
wherein, in the case where the first display section is positioned within a prescribed region on an opposite side to a direction the second display section presents the display information towards a user, the first display section is controlled so at least a part of display information out of the display information displayed on the second display section is displayed.

7. The information processing apparatus according to claim 6,
wherein the first display section is controlled so as to display display information in which the display information displayed on the first display section, and at least a part of display information out of the display information displayed on the second display section, are integrated.

8. The information processing apparatus according to claim 5,
wherein a display of the display information is controlled for the first display section, in accordance with a relative positional relationship of the first display section with respect to the second display section, based on a control which changes a layout of the display information.

9. The information processing apparatus according to claim 8,
wherein a display of the display information is controlled for the first display section, in accordance with a display position of display information displayed on the second display section, based on a control which changes a layout of display information displayed on the first display section.

10. The information processing apparatus according to claim 5,
wherein a display of the display information is controlled for the first display section, in accordance with a relative positional relationship of the first display section with respect to the second display section, and a display mode of the display information on the second display section, based on a control which changes a display mode of the display information displayed on the first display section.

11. The information processing apparatus according to claim 10,
wherein a display of the display information is controlled for the first display section, in the case where the first display section is positioned within a prescribed region on an opposite side to a direction the second display section presents the display information towards a user, so a display mode of the display information displayed on the first display section changes based on a display mode of the display information on the second display section.

12. The information processing apparatus according to claim 10,
wherein a display of the display information is controlled for the first display section based on a control which changes a magnification ratio of the display information as the display mode.

13. The information processing apparatus according to claim 1, further comprising:
a control section which executes, in accordance with a relative positional relationship between the first display section and the second display section, at least one of a control of a display destination of the display information and a control of the layout.

14. The information processing apparatus according to claim 13, further comprising:
a position information acquisition section which acquires position information showing a relative positional relationship between the first display section and the second display section,
wherein the control section executes at least one of a control of a display destination of the display information and a control of the layout, based on the acquired position information.

15. An information processing method, comprising:
acquiring display information;
displaying, by a processor, the display information on a first display section; and
controlling a display of the display information to the first display section, in accordance with a relative positional relationship between the first display section and a second display section provided in an external apparatus, based on at least one of a control of a display destination of the display information between the first display section and the second display section, and a control of a layout of the display information displayed on the first display section.

16. An information processing system, comprising:
a first information processing apparatus including a first display section;
a second information processing apparatus including a second display section; and
a control section which controls, in accordance with a relative positional relationship between the first display section and the second display section, at least one of a display destination of display information between the first display section and the second display section, and a layout of the display information displayed on the first display section.

17. An information processing apparatus, comprising:
an information acquisition section which acquires display information; and
a control section which controls, in accordance with a relative positional relationship between a first display section and a second display section provided in a different apparatus to the first display section, at least one of a display destination of the display information between the first display section and the second display section, and a layout of the display information displayed on the first display section.
